(19) United States
(12) Patent Application Publication
(10) Pub. No.: US 2015/0192826 A1
(43) Pub. Date: Jul. 9, 2015

(54) COLOR FILTER SUBSTRATE, DISPLAY PANEL AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: LIFENG LIN, BEIJING (CN); HONGMING ZHAN, BEIJING (CN); YONGCAN WANG, BEIJING (CN)

(21) Appl. No.: 14/372,994

(22) PCT Filed: Jun. 26, 2013
(86) PCT No.: PCT/CN2013/077943

§ 371 Date: Jul. 17, 2014

(30) Foreign Application Priority Data
Mar. 29, 2013 (CN) 201310109035.4

(51) Int. Cl. G02F 1/1335; G02B 5/20

(52) U.S. Cl. CPC G02F 1/133514; G02B 5/201

(57) ABSTRACT

A color filter substrate, a display panel and a display device are disclosed. The color filter substrate comprises a matrix formed of a plurality of pixel areas each comprising four sub-pixel areas corresponding to color filters of four colors respectively, the four colors are red primary color, green primary color, blue primary color and fourth color respectively, the fourth color is green and has a chroma different from that of the green primary color. With a color filter substrate with color filters of four colors, a corresponding array substrate and a thin film transistor driving mode, it is possible to realize a color representation capability of liquid crystal display reaching Adobe 100% while not reducing transmittance of the display panel as best as possible.

### TECHNICAL FIELD

Embodiments of the present invention relate to a color filter substrate, a display panel and a display device.

### BACKGROUND

A traditional liquid crystal panel includes a pixel matrix disposed on an array substrate. Each pixel is in turn divided into red, green and blue (RGB) sub-pixels. Correspondingly, respective sub-pixel areas are disposed on the color filter substrate each corresponding to respective color filter. As illustrated in FIG. 1, the RGB sub-pixel areas in the figure correspond to the red, green and blue primary colors respectively, and are therefore called Normal RGB, where a, b, c denote areas of Normal R, Normal G and Normal B sub-pixel areas respectively. Given constant other conditions, performance of RGB resins on the color filter substrate that correspond to RGB sub-pixel areas will determine the color representation capability and transmittance of the liquid crystal display.

In the industry, color representation capability specifications for liquid crystal displays are classified into the following from low to high: NTSC (National Television Standards Committee) below 72%; NTSC 72%, sRGB 100% matching rate (standard Red Green Blue 100% matching rate, hereinafter sRGB 100%), Adobe 100% matching rate (hereinafter Adobe 100%).

sRGB 100% and Adobe 100% are both high-end product requirements with standard chromaticity coordinates of red primary color, green primary color and blue primary color as illustrated in the following Table 1, where red primary color and blue primary color have the same specification under the two standards while green primary color has a different specifications; the green primary color in Adobe specification has a wider color gamut range than that in sRGB specification, and the color representation capability of sRGB specification can only correspond to 74.1% of the Adobe specification.

TABLE 1

| | |
|---|---|
| Adobe | sRGB |
| standard | standard |

| Chromaticity coordinates | x | y | x | y |
|---|---|---|---|---|
| Red primary color R(red) | 0.640 | 0.330 | 0.640 | 0.330 |
| Green primary color G(green) | 0.210 | 0.710 | 0.300 | 0.600 |
| Blue primary color B(blue) | 0.150 | 0.060 | 0.150 | 0.060 |

| | | |
|---|---|---|
| NTSC Gamut | 95.5% | 70.8% |
| Adobe 100% Matching Rate | 100% | 74.1% |
| sRGB 100% Matching Rate | 100% | 100% |

NTSC Gamut refers to the ratio of an area of the triangle formed by chromaticity coordinates (x, y) of practical product's RGB to an area of the triangle formed by chromaticity coordinates (x, y) of standard RGB primary colors of NTSC; sRGB 100% Matching Rate refers to the ratio of an overlapping area between the triangle formed by chromaticity coordinates (x, y) of practical product's RGB and the triangle formed by standard RGB chromaticity coordinates (x, y) of sRGB to an area of the triangle formed by standard RGB chromaticity coordinates (x, y) of sRGB; and Adobe 100% Matching Rate refers to the ratio of an overlapping area between the triangle formed by chromaticity coordinates (x, y) of practical product's RGB and the triangle formed by RGB primary colors' chromaticity coordinates (x, y) of Adobe standard to an area of the triangle formed by RGB primary colors' chromaticity coordinates (x, y) of Adobe standard.

A color is represented by chroma and brightness together. Chroma is used to evaluate color quality stimulation, and represented in a value expressed by chromaticity coordinates generally. Brightness refers to the bright degree of a picture and has a unit of candela per square meter (cd/m2) or nits. Therefore, x, y in Table 1 represent chromaticity coordinates respectively wherein chromaticity coordinates of red primary color (Red), green primary color (Green) and blue primary color (Blue) corresponding to Adobe specification and sRGB specification are given, and color representation capabilities corresponding to Adobe specification and sRGB specification conditions.

There are already established solutions at present corresponding to sRGB 100%. However, from sRGB 100% to Adobe 100%, replacing of resin for green primary color G is one of the main methods. The following Table 2 is one instance before and after the replacement, where Gx, Gy are chromaticity coordinates, Gy denotes transmittance, Normal G denotes green primary color under sRGB standard, New G denotes the green primary color corresponding to the newly replaced G resin. As can be seen from Table 2, the New G introduced for implement Adobe 100% has a transmittance decreased by about 50%. Since the transmittance of G resin's influence on the transmittance of the liquid crystal panel accounts for 70%, replacing G resin for realizing the transition from sRGB 100% to Adobe 100% will lower the total transmittance of the liquid crystal panel by about 35%. Values of Normal G, New G chromaticity coordinates and transmittance illustrated in Table 2 are all experimental values, since it's difficult for chromaticity coordinates of various colors in practice to reach chromaticity coordinates under sRGB standard or Adobe standard.

TABLE 2

| | Normal G | New G |
|---|---|---|
| Gx | 0.284 | 0.231 |
| Gy | 0.593 | 0.664 |
| GY | 0.560 | 0.273 |

From the above, the traditional approach of replacing G resin has significant impact on the transmittance of liquid crystal panels and is adverse to improvement of display quality of the liquid crystal panels.

### SUMMARY

One embodiment of the present invention provides a color filter substrate comprising a matrix formed of a plurality of pixel areas each comprising four sub-pixel areas corresponding to color filters of four colors respectively; the four colors are red primary color, green primary color, blue primary color and fourth color respectively, and the fourth color is green and has a chroma different from that of the green primary color.

Another embodiment of the present invention provides a display panel comprising an array substrate and a color filter substrate as described above, the array substrate comprises a matrix formed of a plurality of pixel areas each comprising four sub-pixel areas in one to one correspondence with sub-pixel areas on the color filter substrate respectively, and each sub-pixel area on the array substrate comprises a thin film transistor switch.

Another embodiment of the present invention further provides a display device including the above-mentioned display panel.

### BRIEF DESCRIPTION OF DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of a pixel of a traditional color filter substrate, wherein the pixel contains Normal RGB sub-pixels, a is the area of Normal R sub-pixel, b is the area of Normal G sub-pixel, and c is the area of Normal B sub-pixel;

FIG. 2 is a schematic diagram of a pixel of a color filter substrate in an embodiment of the present invention, wherein the pixel contains four sub-pixels, namely Normal RGB+New G; and

FIGS. 3 to 5 are schematic diagrams of arrangement of four color sub-pixels on the color filter substrate in embodiments of the present invention respectively, wherein a is the area of Normal R sub-pixel, b is the area of Normal G sub-pixel, c is the area of Normal B sub-pixel, and d is the area of New G sub-pixel.

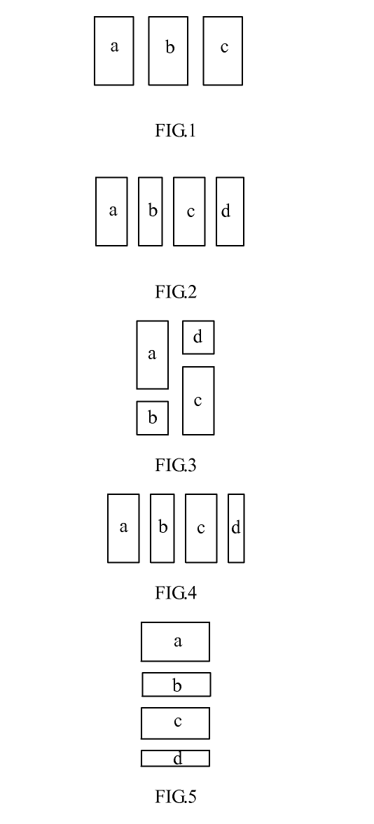

### DETAIL DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

### Embodiment 1

As illustrated in FIG. 2, the present embodiment provides a color filter substrate including a matrix formed of a plurality of pixel areas each including four sub-pixel areas corresponding to color filters of four colors respectively. The four colors are red primary color (Normal R), green primary color (Normal G), blue primary color (Normal B), and the fourth color respectively. The fourth color is green (New G) with a chroma different from that of the green primary color.

Specifically, the red primary color has a chromaticity coordinate of (0.640±0.030, 0.330±0.030), the green primary color has a chromaticity coordinate of (0.300±0.030, 0.600±0.030), the blue primary color has a chromaticity coordinate of (0.150±0.030, 0.060±0.030), and the fourth color has a chromaticity coordinate of (0.210±0.030, 0.710±0.030). It is understood that, the above-mentioned chromaticity coordinate values are standard chromaticity coordinates of red primary color, green primary color and blue primary color under sRGB standard and green primary color under Adobe standard, and in practice, chromaticity coordinates of the colors are not necessarily the same as the above mentioned chromaticity coordinates. Here, the chromaticity coordinates are not limited to specific values. It's intended to mean that red primary color, green primary color and blue primary color in the embodiment are red primary color, green primary color and blue primary color of sRGB standard, and the fourth color is the green primary color of Adobe standard. Chromaticity coordinates of the above-mentioned four colors may vary in the above-mentioned ranges depending on influences of factors such as the display panel's product specification, material selection, processes and outside temperature and environments, and are not limited to any certain values.

In addition, in four sub-pixel areas of each pixel area, the area ratio of color filters for the red primary color, green primary color, blue primary color and fourth color, a:b:c:d is (1˜1.5):(0.5˜1):(0.75˜1.25):(0.5˜1). This ratio range can meet requirements on display panel products of common specification, and the transmittance variation will not impose adverse effect on the display quality of the display panels while its color representation capability is realized to reach Adobe 100%.

In the embodiment of the present invention, for example, in four sub-pixel areas of each pixel area, the area ratio of color filters for the red primary color, green primary color, blue primary color and fourth color, a:b:c:d is (1˜1.5):0.75:(0.75˜1.25):(0.5˜1); or a:b:c:d is (1˜1.5):(0.5˜1):1:(0.5˜1). Since the color filter of the fourth color is added to improve color representation capability and transmittance of a display panel in combination with the color filter of green primary color, the area occupied by the color filter of green primary color may be smaller than 1, and not bigger than the area proportions occupied by the color filters for red primary color and blue primary color respectively at the same time. It is allowed that color filters of red primary color and blue primary color occupy area proportions of about 1 respectively, such as 1, which means that the contributions by the color filter of red primary color and the color filter of blue primary color varies very little before and after adding the color filter of the fourth color, and primarily, green primary color and the fourth color are combined to realize the effect of green color filter.

In the present embodiment, in each pixel, the sub-pixels of the red primary color, the green primary color, the blue primary color and the fourth color are arranged in order in the horizontal direction or arranged in order in the vertical direction; alternatively, in each pixel, the sub-pixels of the red primary color, the green primary color, the blue primary color and the fourth color are arranged diagonally in a square, with the green primary color and the fourth color being located at diagonal corners, that is, the green primary color and the fourth color are located at the upper left corner and at the lower right corner, or at the lower left corner and at the upper right corner respectively. Of course, arrangements for the four kinds of sub-pixels of the colors are not limited to the above-mentioned ones, and their arrangement order is not limited so long as uniform color mixing of the four color sub-pixels can be realized.

Hereinafter, a specific example is elected to explain the structure improvements of the liquid crystal panel in an embodiment of the present invention. For example, there are four kinds of resins with characteristics illustrated in the following Table 3, with red primary color, green primary color, blue primary color and fourth color being represented by Normal R, Normal G, Normal B and New G respectively, where x, y denote chromaticity coordinates respectively and y denotes transmittance. As can be known from Table 3, the red primary color used in the following example has a chromaticity coordinate of (0.640, 0.330), the green primary color has a chromaticity coordinate of (0.300, 0.600), the blue primary color has a chromaticity coordinate of (0.150, 0.060), and the fourth color has a chromaticity coordinate of (0.210, 0.710).

TABLE 3

| | Normal R | Normal G | Normal B | New G |
|---|---|---|---|---|
| x | 0.640 | 0.300 | 0.150 | 0.210 |
| y | 0.330 | 0.600 | 0.060 | 0.710 |
| Y | 18.0% | 60.0% | 6.0% | 30.0% |

When the above-mentioned four kinds of resins are combined at different area ratios of a:b:c:d (Normal R: Normal G: Normal B: New G), different characteristics will be exhibited as illustrated in the following Table 4.

TABLE 4

| Implementation | | | | | | | |
|---|---|---|---|---|---|---|---|
| scheme | (1) | (2) | (3) | (4) | (5) | (6) | (7) |
| a:b:c:d | 1:1:1:0 | 1:0:1:1 | 1:0.5:1:0.5 | 1.25:0.75:1:0.5 | 1:0.75:1.25:0.5 | 1.5:0.75:1:0.5 | 1:0.75:0.75:0.5 |
| White light x | 0.314 | 0.299 | 0.307 | 0.324 | 0.292 | 0.339 | 0.327 |
| White light y | 0.330 | 0.274 | 0.306 | 0.335 | 0.310 | 0.335 | 0.336 |
| White light Y | 28.0% | 18.0% | 23.0% | 25.3% | 24.4% | 24.8% | 24.5% |
| Color temperature | 6432 | 8626 | 7085 | 5905 | 8081 | 5187 | 5752 |
| sRGB 100% | 100.0% | 100.0% | 100.0% | 100.0% | 100.0% | 100.0% | 100.0% |
| matching rate | | | | | | | |
| Adobe 100% | 74.1% | 100.0% | 100.0% | 100.0% | 100.0% | 100.0% | 100.0% |
| matching rate | | | | | | | |
| Transmittance | 0% | 35.7% | 17.9% | 9.7% | 12.8% | 11.4% | 12.03% |
| reduced by | (reference) | | | | | | |

As can be seen from the above table, the area proportion of Normal R, G, and B & New G and corresponding display effect of the display panel are the following respectively:

The first column of data corresponding to a:b:c:d=1:1:1:0 has the meaning as described below:

In this case, the display panel uses a color filter substrate formed of color filters of red primary color, green primary color, and blue primary color, with the white light formed by the color filters of the three kinds of colors correspondingly possessing a chromaticity coordinate of (0.314, 0.330), a transmittance of 28.0%, a color temperature of 6432, and the corresponding color representation capability of the display panel reaching sRGB 100.0% but only Adobe 74.1%. The transmittance of the display panel now is taken as a reference for comparison, and its transmittance reduction is expressed as 0% as references for subsequent experiments.

(2) The second column of data corresponding to a:b:c:d=1:0:1:1 has the meaning as described below:

In this case, the display panel uses a color filter substrate formed of color filters of red primary color, blue primary color and the above-mentioned fourth color instead of green primary color, with the white light formed by the color filters of the three kinds of colors correspondingly possessing a chromaticity coordinate of (0.299, 0.274), a transmittance of 18.0%, a color temperature of 8626, and the corresponding color representation capability of the display panel reaching sRGB 100.0% and Adobe 100.0% at the same time.

In this scheme, the Adobe 100% scheme is realized by changing color filter of green primary color, however the transmittance is reduced by 35.7%, and the color temperature is higher as compared to the sRGB 100% scheme, which tends to impose adverse influence on the display panel.

(3) The third column of data corresponding to a:b:c:d=1:0.5:1:0.5 has the meaning as described below:

In this case, the display panel uses a color filter substrate formed of color filters of red primary color, green primary color, blue primary color and the above-mentioned fourth color in combination, with the white light formed by color filters of the four colors correspondingly possessing a chromaticity coordinate of (0.307, 0.306), a transmittance of 23.0%, a color temperature of 7085, and the corresponding color representation capability of the display panel reaching sRGB 100.0% and Adobe 100.0% at the same time.

In this scheme, with the combination of the color filters for the green primary color and the fourth color, the Adobe 100% scheme is realized, with the transmittance being reduced by only 17.9%, which is one half of the transmittance loss (35.7%) of the scheme (2) in which Adobe 100% is realized by replacing the color filter of the green primary color with the color filter of the fourth color. As can be known, the combination of the color filter of the green primary color with the color filter of the fourth color can enable the color representation capability of the display panel to reach Adobe 100%, the color temperature will not be significantly higher and the transmittance will not decrease significantly, which will not impose adverse influence on the display effect of the display panel.

(4) The fourth column of data corresponding to a:b:c:d=1.25:0.75:1:0.5 has the meaning as described below:

In this case, the display panel uses a color filter substrate formed of color filters of red primary color, green primary color, blue primary color and the above-mentioned fourth color in combination, with the white light formed by color filters of the four colors correspondingly possessing a chromaticity coordinate of (0.324, 0.335), a transmittance of 25.3%, a color temperature of 5905, and the corresponding color representation capability of the display panel reaching sRGB 100.0% and Adobe 100.0% at the same time.

In this scheme, by combining the color filter of the green primary color and the color filter of the fourth color, the Adobe 100% scheme is realized, with the transmittance being reduced by only 9.7%, which is smaller than the transmittance loss (35.7%) of the scheme (2) in which Adobe 100% is realized by replacing the color filter of the green primary color with the color filter of the fourth color. As can be known, the combination of the color filter of the green primary color with the color filter of the fourth color can enable the color representation capability of the display panel to reach Adobe 100%, the color temperature will not be significantly higher and the transmittance will not decrease significantly, which will not impose adverse influence on the display effect of the display panel.

(5) The fifth column of data corresponding to a:b:c:d=1:0.75:1.25:0.5 has the meaning as described below:

In this case, the display panel uses a color filter substrate formed of color filters of red primary color, green primary color, blue primary color and the above-mentioned fourth color in combination, with the white light formed by color filters of the four colors correspondingly possessing a chromaticity coordinate of (0.292, 0.310), a transmittance of 24.4%, a color temperature of 8081, and the corresponding color representation capability of the display panel reaching sRGB 100.0% and Adobe 100.0% at the same time.

In this scheme, by combining the color filter of the green primary color and the color filter of the fourth color, the Adobe 100% scheme is realized, with the transmittance being reduced by only 12.8%, which is smaller than the transmittance loss (35.7%) of the scheme (2) in which Adobe 100% is realized by replacing the color filter of the green primary color with the color filter of the fourth color. As can be known, the combination of the color filter of the green primary color with the color filter of the fourth color can enable the color representation capability of the display panel to reach Adobe 100%, the color temperature is lowered with respect to the scheme in which Adobe 100% is realized by replacing the color filter of the green primary color with the color filter of the fourth color, and the transmittance will not decrease significantly, which will not impose adverse influence on the display effect of the display panel.

(6) The sixth column of data corresponding to a:b:c:d=1.5:0.75:1:0.5 has the meaning as described below:

In this case, the display panel uses a color filter substrate formed of color filters of red primary color, green primary color, blue primary color and the above-mentioned fourth color in combination, with the white light formed by color filters of the four colors correspondingly possessing a chromaticity coordinate of (0.339, 0.335), a transmittance of 24.8%, a color temperature of 5187, and the corresponding color representation capability of the display panel reaching sRGB 100.0% and Adobe 100.0% at the same time.

In this scheme, by combining the color filter of the green primary color and the color filter of the fourth color, the Adobe 100% scheme is realized, with the transmittance reduced by only 11.4%, which is smaller than the transmittance loss (35.7%) of the scheme (2) in which Adobe 100% is realized by replacing the color filter of the green primary color with the color filter of the fourth color. As can be known, the combination of the color filter of the green primary color with the color filter of the fourth color can enable the color representation capability of the display panel to reach Adobe 100%, the color temperature is not higher than the scheme in which Adobe 100% is realized by replacing the color filter of the green primary color with the color filter of the fourth color, and the transmittance will not decrease significantly, which will not impose adverse influence on the display effect of the display panel.

(7) The seventh column of data corresponding to a:b:c:d=1:0.75:0.75:0.5 has the meaning as described below:

In this case, the display panel uses a color filter substrate formed of color filters of red primary color, green primary color, blue primary color and the above-mentioned fourth color in combination, with the white light formed by color filters of the four colors correspondingly possessing a chromaticity coordinate of (0.327, 0.336), a transmittance of 24.5%, a color temperature of 5752, and the corresponding color representation capability of the display panel reaching sRGB 100.0% and Adobe 100.0% at the same time.

In this scheme, by combining the color filter of the green primary color and the color filter of the fourth color, the Adobe 100% scheme is realized, with the transmittance reduced by only 12.03%, which is smaller than the transmittance loss (35.7%) of the scheme (2) in which Adobe 100% is realized by replacing the color filter of the green primary color with the color filter of the fourth color. As can be known, combining the color filter of the green primary color with the color filter of the fourth color can enable the color representation capability of the display panel to reach Adobe 100%, the color temperature is not higher than the scheme in which Adobe 100% is realized by replacing the color filter of the green primary color with the color filter of the fourth color, and the transmittance will not decrease significantly, which will not impose adverse influence on the display effect of the display panel.

In this embodiment, the color filter substrate is formed of color filters of the red primary color, green primary color and blue primary color in sRGB standard as well as the green primary color in Adobe RGB standard as the fourth color, where the area proportion of the color filters of the four colors is a:b:c:d=1:0.5:1:0.5. In each pixel, the sub-pixels of the four colors are arranged diagonally in a square as illustrated in FIG. 3, with the green primary color and the fourth color being located at diagonal corners, that is, the green primary color and fourth color are located at the upper left corner and the lower right corner or at the lower left color and the upper right corner respectively. Alternatively, in each pixel, the sub-pixels of the four colors are arranged in a horizontal strip as illustrated in FIG. 4 or in a vertical strip as illustrated in FIG. 5. Of course, arrangements for the sub-pixels of the four colors are not limited to the above-mentioned ones, and their arrangement order is not limited so long as uniform color mixing of the four color sub-pixels can be realized.

Based on the above-mentioned color filter substrate, the present embodiment further provides a display panel including an array substrate and the above-mentioned color filter substrate. The array substrate further includes a matrix formed of a plurality of pixel areas each including four sub-pixel areas in one to one correspondence with sub-pixel areas on the color filter substrate respectively, and each containing a thin film transistor switch.

An embodiment of the present invention further provides a display device that can be manufactured with the above-mentioned display panel. The display device may be any product or component with display function, such as a liquid crystal TV, a notebook computer, a slab computer, a mobile telephone, a digital picture frame, electronic paper.

### Embodiment 2

The color filter substrate provided in the present embodiment is similar to the color filter substrate in embodiment 1 in terms of structure, and is formed of color filters of red primary color, green primary color, blue primary color and fourth color, where the red primary color, green primary color, blue primary color are the red primary color, green primary color and blue primary color in sRGB standard, the fourth color is the green primary color in Adobe standard, with chromaticity coordinates of the four colors same as that of red primary color, green primary color, blue primary color and the fourth color in embodiment 1, which will not be described in detail any more here.

In this embodiment, for example, the area proportion of the color filters of the four colors, a:b:c:d=1:0.75:1:0.5, the white light formed accordingly by color filters of the four colors possesses a chromaticity coordinate of (0.307, 0.335), a transmittance of 25.8%, a color temperature of 6790, and a corresponding color representation capability of the display panel reaching sRGB 100.0% and reaching Adobe 100.0% at the same time. As illustrated in FIG. 4, in each pixel, the sub-pixels of the four colors are arranged in order in the horizontal direction and the transmittance of the display panel is reduced by only 7.7%, which realizes a color representation capability of the display panel reaching Adobe 100.0% and ensures that its transmittance to meet the demand.

The color filter substrate of the present embodiment can also be used to manufacture display panels and display devices as the color filter substrate in embodiment 1, which will not be described any more here.

In practical manufacturing process of liquid crystal panels, in the above-mentioned four sub-pixels, the proportion of the area of each sub-pixel to the entire area of the four sub-pixels and the proportion among the areas of the four sub-pixels may vary depending on the influence of factors such as liquid crystal panel's product specification and outside temperature environment, and are not completely limited to the above-mentioned proportion values.

In the combination of Normal R, G, and B and New G described in embodiments of the present invention, namely in the scheme of realizing Adobe 100% by combining the red primary color, green primary color and blue primary color in sRGB standard (Normal R, G, and B) and the green primary color in Adobe RGB standard (New G), the area proportion between Normal R, G, and B and New G is not limited to the above-mentioned several proportions, and can be adjusted according to requirements of the product specification.

As can be seen from the above embodiments, the present invention can realize the color representation capability of a liquid crystal display of Adobe 100% while not reducing the transmittance of the display panel to the greatest extend by providing a color filter substrate with color filters of four colors correspondingly along with an array substrate and a thin film transistor driving mode, leading to significant consequence of improving display quality of the display panel and the display device.

The above embodiments only serve to explain the technical proposal of the present invention rather than limiting it; though the present invention has be described in detail with reference to the aforementioned embodiments, those of ordinary skill in the art should understand that they can still make modifications to the technical proposal recited in the aforementioned various embodiments or make equivalent substitutions to partial technical features therein; and all these modifications or substitutions will not make the nature of respective technical proposals to depart from the spirit and scope of the technical proposals of embodiments of the present invention.

1. A color filter substrate comprising a matrix formed of a plurality of pixel areas each comprising four sub-pixel areas corresponding to color filters of four colors respectively, wherein the four colors are red primary color, green primary color, blue primary color and fourth color respectively, the fourth color is green and has a chroma different from that of the green primary color.

2. The color filter substrate of claim 1, wherein the red primary color has a chromaticity coordinate of (0.640±0.030, 0.330±0.030), the green primary color has a chromaticity coordinate of (0.300±0.030, 0.600±0.030), the blue primary color has a chromaticity coordinate of (0.150±0.030, 0.060±0.030), and the fourth color has a chromaticity coordinate of (0.210±0.030, 0.710±0.030).

3. The color filter substrate of claim 2, wherein for the four sub-pixel areas of each pixel area, an area ratio of the color filters of the red primary color, the green primary color, the blue primary color and the fourth color is (1˜1.5):(0.5˜1):(0.75˜1.25):(0.5˜1).

4. The color filter substrate of claim 3, wherein for the four sub-pixel areas of each pixel area, the area ratio of the color filters of the red primary color, the green primary color, the blue primary color and the fourth color is (1˜1.5):0.75:(0.75˜1.25):(0.5˜1).

5. The color filter substrate of claim 3, wherein for the four sub-pixel areas of each pixel area, the area ratio of the color filters of the red primary color, the green primary color, the blue primary color and the fourth color is (1˜1.5):(0.5˜1):1: (0.5˜1).

6. The color filter substrate of claim 3, wherein for the four sub-pixel areas of each pixel area, the area ratio of the color filters of the red primary color, the green primary color, the blue primary color and the fourth color is 1:0.75:1:0.5.

7. The color filter substrate of claim 2, wherein in each pixel, the red primary color, the green primary color, the blue primary color and the fourth color sub-pixels are arranged in order in a horizontal direction or arranged in order in a vertical direction.

8. The color filter substrate of claim 2, wherein in each pixel, the red primary color, the green primary color, the blue primary color and the fourth color sub-pixels are arranged diagonally in a square with the green primary color and the fourth color being located at diagonal corners of the square.

9. A display panel comprising an array substrate and a color filter substrate of claim 1, the array substrate comprising a matrix formed of a plurality of pixel areas each comprising four sub-pixel areas in one to one correspondence with sub-pixel areas on the color filter substrate respectively, and each sub-pixel area on the array substrate comprising a thin film transistor switch.

10. A display device comprising a display panel of claim 9.

11. The color filter substrate of claim 4, wherein for the four sub-pixel areas of each pixel area, the area ratio of the color filters of the red primary color, the green primary color, the blue primary color and the fourth color is 1:0.75:1:0.5.

12. The color filter substrate of claim 5, wherein for the four sub-pixel areas of each pixel area, the area ratio of the color filters of the red primary color, the green primary color, the blue primary color and the fourth color is 1:0.75:1:0.5.
